(19) United States
(12) Patent Application Publication
(10) Pub. No.: US 2012/0065029 A1
(43) Pub. Date: Mar. 15, 2012

(54) Selectable Angle Eccentric Arms and Devices

(75) Inventor: Creig Dunlap, Amana, IA (US)

(73) Assignee: Creig Dunlap, Amana, IA (US)

(21) Appl. No.: 13/231,166

(22) Filed: Sep. 13, 2011

Related U.S. Application Data
(60) Provisional application No. 61/382,462, filed on Sep. 13, 2010.

(51) Int. Cl. A63B 22/12; F16H 21/20; F16H 21/00

(52) U.S. Cl. 482/62; 74/522; 74/47

(57) ABSTRACT

Provided herein are selectable angle eccentric arms, devices comprising selectable angle angle eccentric arms, and methods for making such devices. Examplary devices are exercise devices.

### TECHNICAL FIELD

The present invention relates to eccentric arm type devices.

### BACKGROUND

Exercise cycles have been popular for many years. Such cycles enable the user to exercise in a manner similar to that when riding a bicycle while conveniently remaining at home or in a gym. Basic exercise cycles allow only for aerobic and leg conditioning and do not provide a substantial benefit to the arms and upper torso. However, certain exercise cycles also provide for motion of a handlebar or handlever assembly to provide exercise for the arms and upper torso of the user.

Perhaps the most popular of these so-called “dual-action” cycles is the Schwinn® Airdyne® exercise bicycle, which provides for the traditional pedaling motion with the user's feet, and also provides handlebars which move back and forth out of phase with each other. Other dual-action exercise cycles are described in U.S. Pat. No. 4,188,030 (Hooper), U.S. Pat. No. 4,509,742 (Cones), U.S. Pat. No. 4,657,244 (Ross), U.S. Pat. No. 4,712,789 (Brilando), U.S. Pat. No. 4,712,790 (Szymski), and U.S. Pat. No. 4,757,988 (Szymski).

U.S. Pat. No. 4,824,102 (Lo) describes a dual-action cycle comprising handle bar swing levers that are linked to the wheel axel through respective swing arms which may be re-positioned to move in phase with each other. The swing arms are secured to the wheel axel through “key-ways” formed on each end of the axel. The re-positioning is achieved by providing a wheel axel which has two key-ways on one end, wherein the first key way is aligned with the key-way on the other end of the axel, and the second key way is off-set 180 degrees. Although the cycle described by Lo does provides for both reciprocating and tandem motion of the swing levers, the configuration is complex, requiring additional parts such as rollers to slide up and down an elongated plate which must be fixed to the swing lever. The use of such additional movable parts reduces longevity of the device and the configuration is too complex for many consumers. Furthermore, the configuration is not amenable to many pre-existing dual-action cycles as after-market modification without considerable alteration of pre-existing parts (e.g. drilling to install bolts) and without substantial disassembly of the cycle (e.g. the entire wheel assembly to install the axel). Among other deficiencies, the device Lo is also lacking in that it does not also allow for tandem motion of the feet.

### SUMMARY OF THE INVENTION

The present invention provides a selectable-angle eccentric arm which may be mounted to a rotatable shaft (e.g. drive shaft) at a plurality of angles around the axis of rotation (e.g. offset by 180°).

In one embodiment, the selectable-angle eccentric arm comprises eccentric arm body, a shaft mount, and an engageable/disengagable locking member (shaft lock) for fixing the eccentric arm at one of a plurality of angles (e.g. angles offset by 180°) around the axis of rotation. Optionally, the selectable-angle eccentric arm comprises a foot pedal or means for linkage to a foot pedal (e.g. peg with a keyway for acceptance of a foot pedal crank arm with a key).

In one embodiment, the selectable-angle eccentric arm comprises eccentric arm body, a shaft mount, a shaft lock, and drive bar linkage means for linking the eccentric arm body with a drive bar (e.g. a peg for a peghole on a drive bar). Optionally, the shaft lock is a drive shaft pin. Optionally, the selectable-angle eccentric arm comprises a foot pedal or means for linkage to a foot pedal (e.g. peg with a keyway for acceptance of a foot pedal crank arm with a key).

In one embodiment, the selectable-angle eccentric arm comprises eccentric arm body, a shaft mount, and a shaft lock, wherein the shaft lock comprise a drive shaft pin. Optionally, the selectable-angle eccentric arm comprises means for biasing the drive shaft pin with a drive shaft (e.g. a spring).

The invention also provides a drive mechanism comprising at least two eccentric arms mounted to a rotatable shaft (e.g. drive shaft), wherein at least one of the eccentric arms is a selectable angle eccentric arm, e.g. as described above (a ‘dual arm selectable angle drive mechanism’). Optionally, the selectable angle eccentric arm configured to be mounted and fixed to the rotatable shaft in at least two angles around the axis of rotation which are offset 180° from one another. Optionally, the dual arm selectable angle drive mechanism provides a first configuration in which two eccentric arms are offset 180° from one another and a second configuration in which the two eccentric arms are not offset (i.e. mounted at the same angle).

The invention also provides a device comprising the drive mechanism. In one embodiment, the device is a human-powered device. Optionally, the human-powered device is an exercise device or a vehicle. Optionally, the human-powered device is a cycle (e.g. exercise cycle or vehicular cycle) comprising pedals. Optionally, the cycle is an upright cycle or a recumbent cycle. Optionally, device is an exercise cycle and the rotatable shaft is linked to acceleration-resistance and/or momentum-carrying means (e.g. fly wheel). Optionally, the cycle is a single-action (e.g. operated by hands only or feet only) or dual-action cycle (e.g. operated using hands and feet). Optionally, the dual-action cycle is direct drive, dual-action cycle.

The invention also provides a device (e.g. exercise device) comprising:
a. a frame;
b. a drive shaft rotatably carried by the frame;
c. first and second eccentric arms, each extending radially from the drive shaft and comprising a foot pedal; wherein:
   i. the second eccentric arm is oriented about the rotatable shaft at a first angle;
   ii. the first eccentric arm of the pair of eccentric arms comprises a drive shaft lock configured to engage and disengage the first eccentric arm from the drive shaft; wherein:
the first eccentric arm is rotatably fixed to the drive shaft when the shaft lock is engaged with the drive shaft; and
the first eccentric arm is rotatably free from the drive shaft when the shaft lock is disengaged from the drive shaft;
   iii. the drive shaft lock is configured to engage the drive shaft when the first eccentric arm is oriented about the drive shaft at the first angle and when the first eccentric arm is oriented about the drive shaft at a second angle offset relative to the first angle; and
   iv. the first and second eccentric arms rotate in tandem when the first eccentric arm is rotatably fixed to the drive shaft at the first angle and rotate in out of phase when the first eccentric arm is rotatably fixed to the drive shaft at the second angle; and
d. optionally, a means for biasing the drive shaft lock to engage the drive shaft.

In one embodiment, the device further comprises first and second hand levers pivotally mounted to the frame for oscillating movement; and first and second drive bars linking the first and second hand levers to the respective first and second eccentric arms, whereby movement of the hand levers about said pivot mount cranks the eccentric arms and induces rotation of the drive shaft. Optionally, the hand levers are pivotally linked to the drive bars (e.g. by peg/peghole). Optionally, the hand levers are class 1 levers, as described herein. Optionally, the device is a direct drive dual action cycle, wherein the eccentric arms are linked to pedals, and wherein the pedals orbit the drive shaft out of phase when the eccentric arms are offset and orbit the drive shaft in tandem when the eccentric arms are not offset.

In one embodiment, the eccentric arms of the device comprise pedals. Optionally, the pedals comprise foot straps.

In one embodiment, the drive shaft of the device is linked to acceleration resistance means and/or momentum carrying means such as a flywheel. Optionally, the drive shaft is indirectly linked to acceleration resistance means (e.g. by mounting a sprocket on the drive shaft). Optionally, the eccentric arms comprise pedals and/or foot straps.

In one embodiment, the selectable angle eccentric arm of the device comprises a shaft mount configured such that the eccentric arm is rotatably carried by the drive shaft, wherein the first eccentric arm is free to rotate about the drive shaft when the drive shaft lock is disengaged.

In one embodiment, the drive shaft lock of the device is a drive shaft pin. Optionally, the selectable-angle eccentric arm comprises means for biasing the drive shaft pin with a drive shaft (e.g. a spring).

Any of the embodiments and/or optional features described herein can be provided independently or in combination with one or more other embodiments and/or optional features described herein (except where such a combination conflicts with the express teachings of the embodiment).

### DETAILED DESCRIPTION OF THE INVENTION

As used here, the following definitions and abbreviations apply.

“Axial length of rotatable shaft” means a portion of a rotatable comprising the axis of rotation.

“Cross-section” as used herein with respect to a rotatable shaft or an eccentric arm, means a cross section which is perpendicular to the axis of rotation of the rotatable shaft.

“Examplary” (or “e.g.” or “by example”) means a non-limiting example.

“Human-powered device” means a device comprising a drive mechanism in which a rotatable shaft is rotated using human muscle power.

### DESCRIPTION OF THE FIGURES

FIGS. 1-3, 7, 8, 11-14, 20, and 21 depict an devices of the present invention comprising a selectable angle eccentric arm.

FIGS. 4, 17, and 22 depict selectable angle eccentric arms comprising a shaft pin.

FIGS. 5 and 6 depict a selectable angle eccentric arm of the invention.

FIGS. 9, 18, and 19, depict selectable angle eccentric arms comprising shaft lock having D2 symmetry and its respective rotatable shaft.

FIG. 15 depicts an acceleration-resistance member comprising a friction pad.

FIG. 16 depicts an acceleration-resistance member comprising a friction pin.

FIG. 23 depicts a sprocket for rotatably fixing to a drive shaft.

### Frame

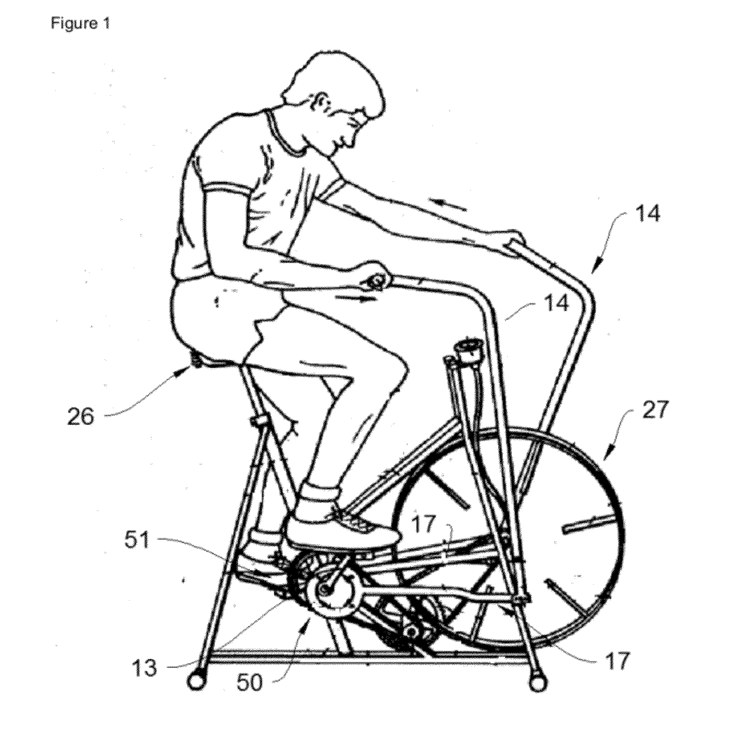

One arm of the invention provides a device comprising a drive mechanism which is supported by a frame. The frame can be any frame that carries or is capable of carrying a rotatable shaft (e.g. drive shaft) comprising an eccentric arm. Generally, the frame of a human-powered device of the present invention will also support the other components of a drive mechanism taught herein. Non limiting examples include, for example, as depicted in FIG. 1, a momentum-carrying or resistance-wheel 27 axel and/or a user seat 26.

With the teachings provided herein, the skilled artisan can provide frames of any design that support and configure components of a drive mechanism.

### Rotatable Shaft

The rotatable shaft can be any rotatable shaft that comprises (or is capable of having mounted to it) an eccentric arm extending radially therefrom. A number of such shafts are known in the art. The rotatable shaft can rotatably carried by a frame (i.e. such that the rotatable shaft can rotate on the frame).

In one embodiment, the rotatable shaft is a drive shaft (e.g. drive shaft of a human-powered device).

In one embodiment, the rotatable shaft is a cam shaft, and the eccentric arm is a cam.

A drive shaft will typically be adapted for linkage to perform work (e.g. turn a bicycle wheel or momentum-carrying or resistance wheel). Such linkage adaptations include, for example, the use of indirect linkages such as sprockets, wheels, and other means for linkage to perform work. However, the present invention also contemplates devices in which resistance is directly mounted to the drive shaft.

The rotatable shaft may be configured to accept the eccentric arm (e.g. a shaft lock of the eccentric arm) at a plurality of angles around the axis of rotation (e.g. offset by 180°).

A rotatable shaft can comprise a portion specifically configured to interface an eccentric arm (e.g. through a shaft lock of the eccentric arm). Optionally, the portion is configured to accept a shaft lock of an eccentric arm at a plurality of alternative angles around the rotatable shaft. Non limiting examples are portions that comprise keyways, passageways (e.g. throughhole or port) or cavities (e.g. with D2 symmetry) for acceptance of a shaft lock.

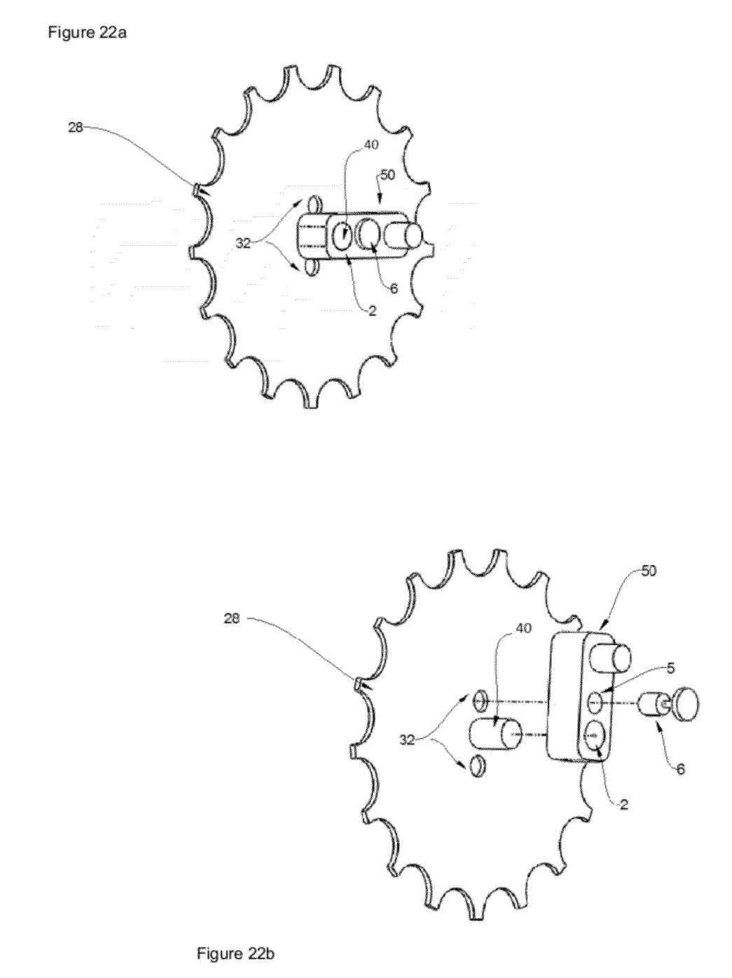

In one embodiment, the portion specifically configured to interface an eccentric arm comprises a substantially circular cross section as in a cylinder. Optionally, such a portion comprises means for interacting with a drive shaft lock. (e.g. with a passageway(s) for acceptance of a shaft pin), for example, as depicted in FIG. 17. Alternatively, a different portion of the rotatable shaft comprises such means (e.g. a sprocket comprising passageways for acceptance of a shaft pin), e.g. as depicted in FIG. 22.

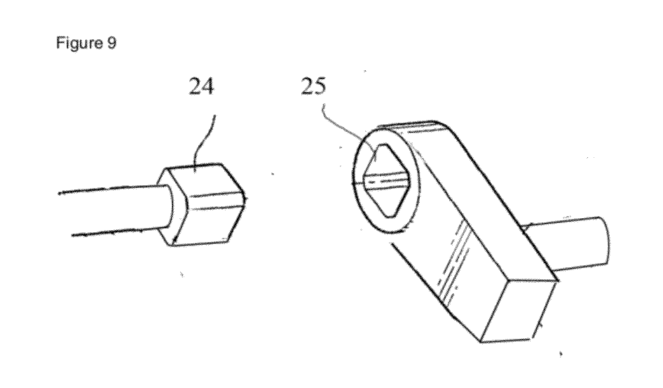

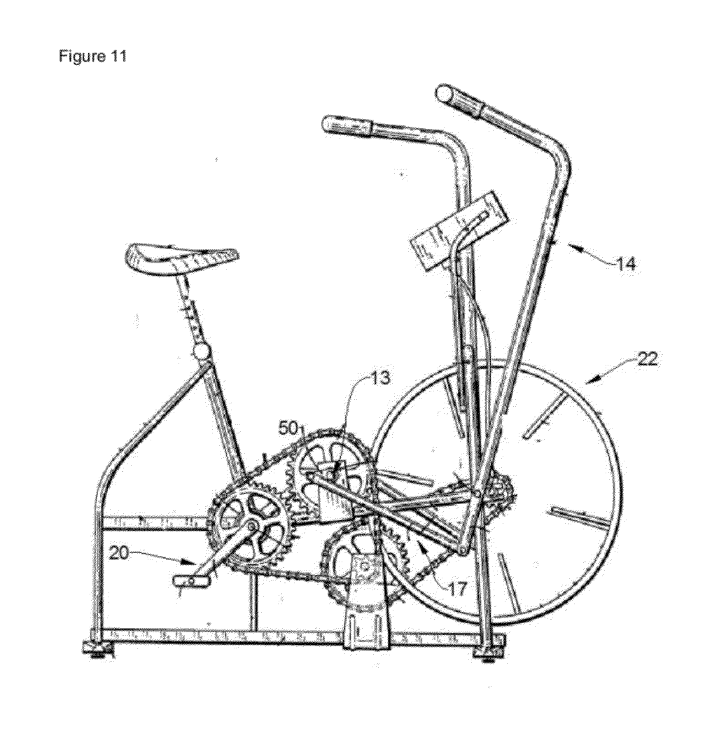

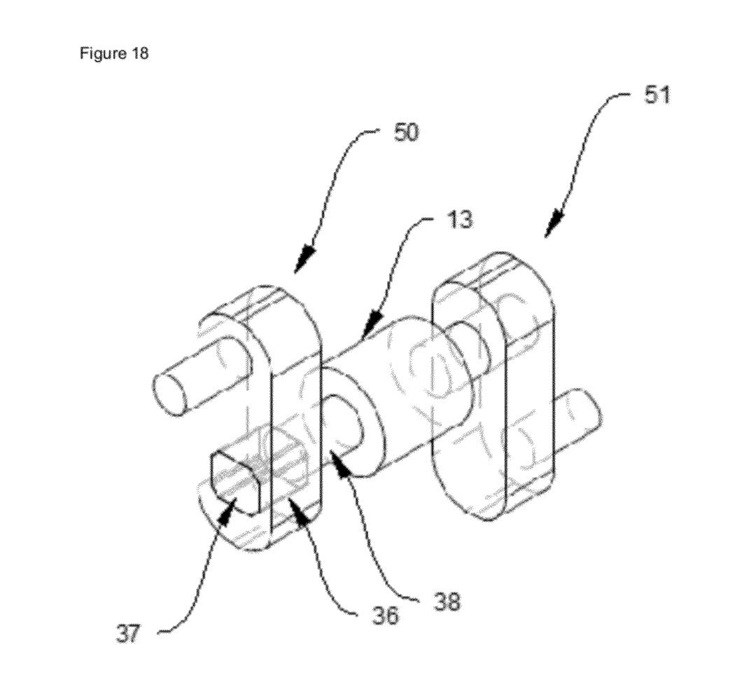

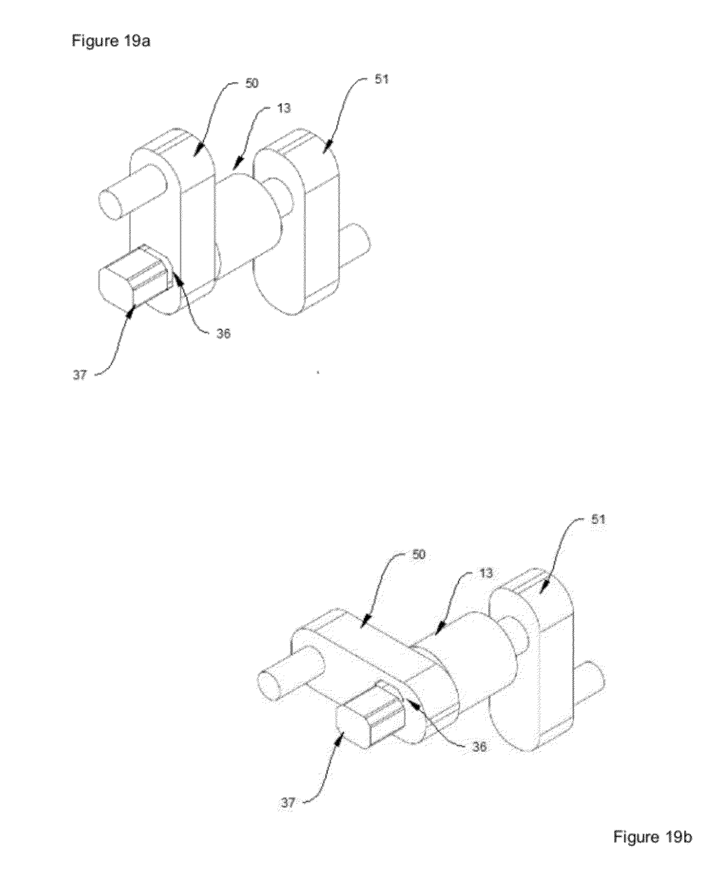

Optionally, the portion (e.g. portion which interacts with a selectable angle eccentric arm) comprises a protrusion with a non-circular cross section (e.g. non-circular prism shaped portion). Optionally, the non-circular cross section comprises D2 symmetry (e.g. rectangle or square for mounting an eccentric arm), for example, as depicted in FIG. 9 and FIG. 18. The use of a cross section with D2 symmetry is especially useful for accepting an eccentric arm at angles offset by 180°. For example, a rotatable shaft which comprises a portion with D2 symmetry (e.g. rectangle) may combined with an eccentric arm having a mount or shaft lock comprising a cavity which accepts the portion at a plurality of angles (offset by 180°) around the axis of rotation, for example, as depicted in FIG. 18 (e.g. a cavity which forms a negative of the same shape or void which itself exhibits D2 symmetry). Optionally, the rotatable shaft comprises a non-circular cross section and/or the eccentric arm (e.g. selectable angle eccentric arm) comprises a mount or shaft lock portion comprising D2 symmetry but not D4 symmetry (e.g. rectangle or diamond). Such a configuration may be used to ensure that the eccentric arm may only interface the rotatable shaft at angles offset by 180°.

As used herein, the term “D2 symmetry” embraces structures which are perfectly D2 symmetrical and also embraces structures which functionally exhibit D2 symmetry. The skilled artisan will recognize that structures with perfect D2 symmetry are not required to practice the invention. For example, in one embodiment, a pair of interacting structures (e.g. rotatable shaft protrusion and shaft mount or shaft lock) with “D2 symmetry” include any protrusion/cavity combination in which the non-circular cavity of eccentric arm can be mounted and rotatable fixed on the non-circular portion of the rotatable shaft in two positioned which are 180° rotatable to each other.

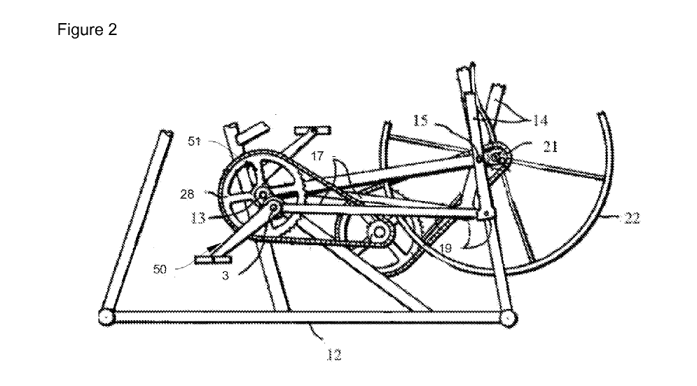

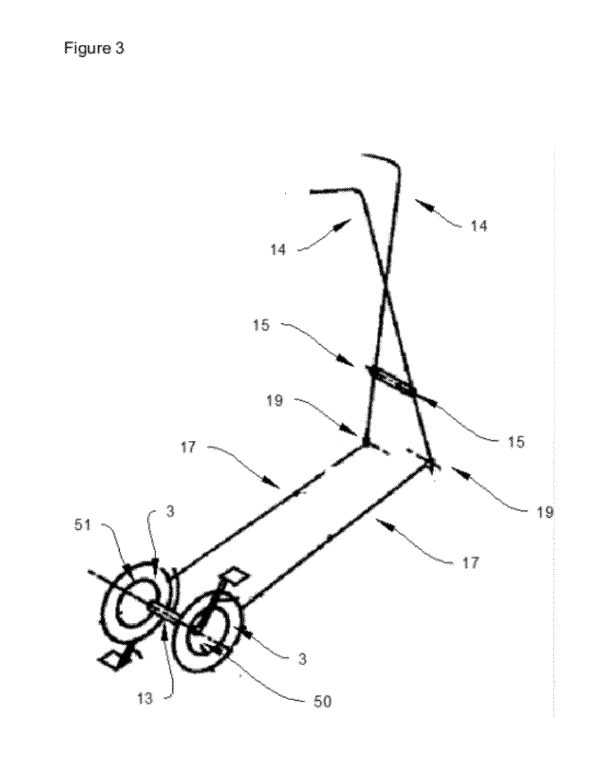

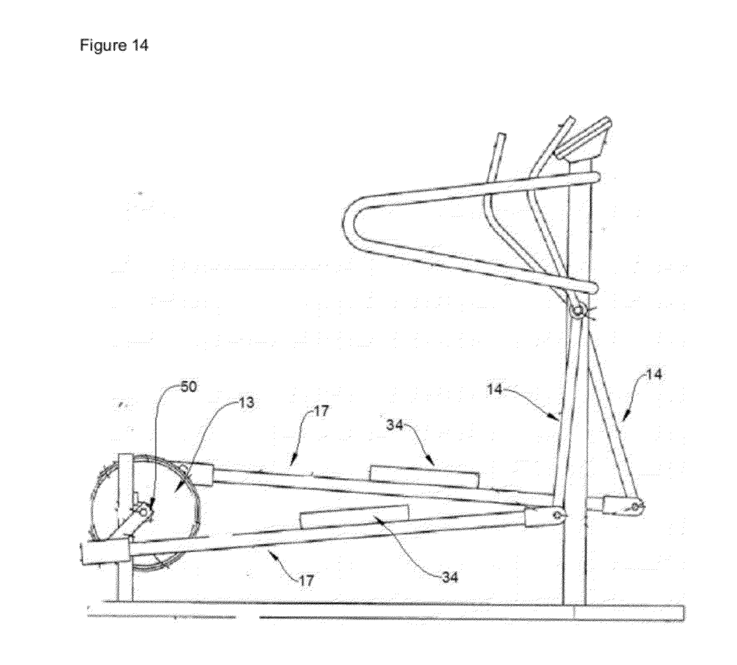

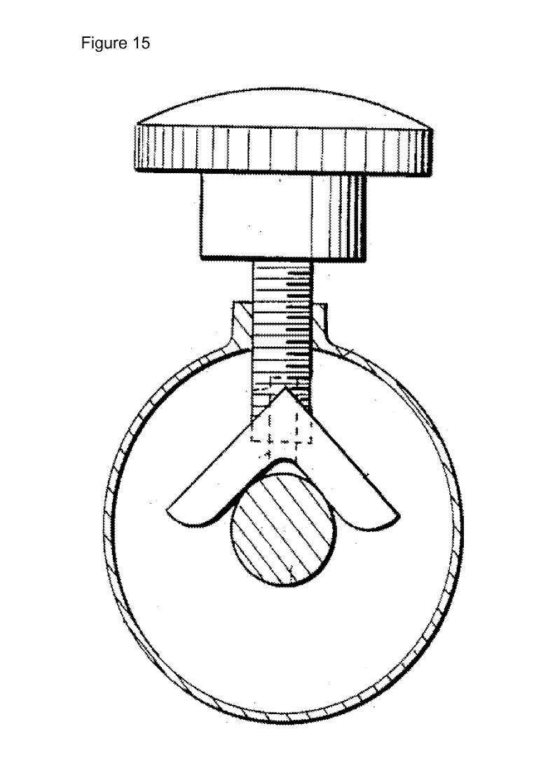

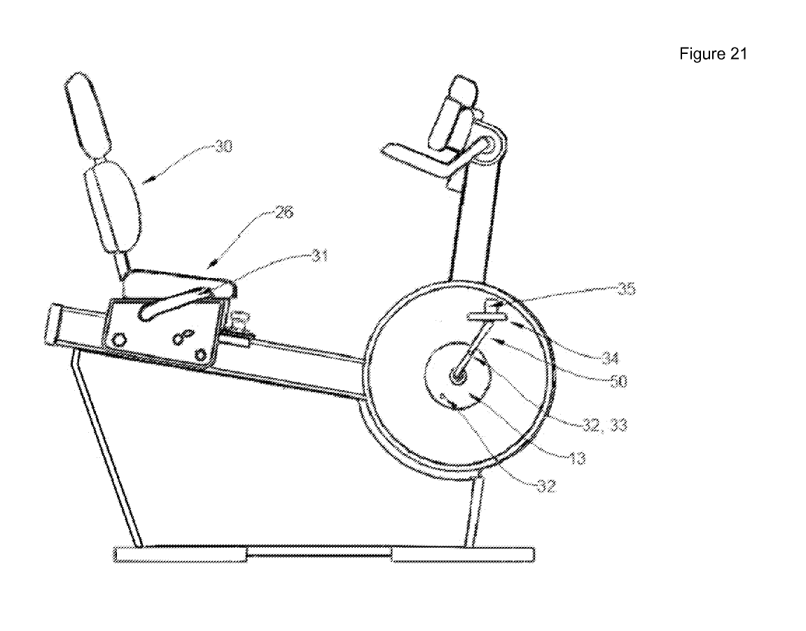

One or more crank arms (e.g. pedal crank arms) may be mounted or otherwise linked to the rotatable shaft (e.g. drive shaft) in order to apply torque to and rotate the rotatable shaft. Optionally, one or more crank arms are fixed to the rotatable shaft (e.g. as shown in FIG. 1 and FIG. 3). Optionally, one or more pedal crank arms are fixed to one or more respective eccentric arms (e.g. as shown in FIG. 2) or are formed as a single body with the eccentric arms (e.g. as depicted in FIG. 21) or are otherwise directly linked (i.e. without the use of sprockets, pulleys, and the like) to the eccentric arm, as depicted in FIG. 14.

### Eccentric Arm

According to the present invention, an eccentric arm extends radially (or is configured to extend radially) from a rotatable shaft and is used to convey a substantially linear force and/or motion (e.g. pedaling of foot pedal crank arm, piston action, or drive bar action) to or from rotational force and/or motion of the rotatable shaft.

Generally, an eccentric arm is configured for mounting to a rotatable shaft, and comprises a body extending radially from the rotatable shaft or axis thereof, and is linked or comprises a means (e.g. peg) for linking to a component (e.g. drive bar and/or foot pedal) which undergoes cyclical or reciprocating (e.g. back and forth) movement.

Any type of eccentric arm known in the art is useful according to the present invention. Optionally, the eccentric arm is a crank arm such as a foot pedal crank arm (e.g. attached to a drive shaft). Optionally, the eccentric arm is an eccentric disk. Optionally, the eccentric arm is a cam (e.g. attached to camshaft).

In one embodiment, a drive mechanism comprises a pair (or more) of eccentric arms mounted to a rotatable shaft, wherein at least one of the eccentric arms is a selectable angle eccentric arm. Optionally, the eccentric arms are crank arms such as foot pedal crank arms. Optionally, one of the eccentric arm is a standard (non-selectable angle) eccentric arm. Such standard eccentric arms are known in the art and can comprise, for example, only a single key for mounting on a drive shaft with a single keyway at only a single angle.

In one embodiment, an eccentric arm (e.g. selectable-angle eccentric arm) comprises a means for linking to a drive bar (e.g. a peg) and the eccentric arm further comprises (or is configured for attachment to, e.g. by comprising a peg with a keyway) a pedal crank arm. The angular position of the pedal can be substantially equal to that of the eccentric arm or may be offset from means for linking to a drive bar (e.g. as shown in FIG. 2). Optionally, the pedal crank arm is perpendicular to the portion of the eccentric arm that connects the rotatable shaft with the means for linking to a drive bar (e.g. as shown in FIG. 2).

### Selectable-Angle Eccentric Arm

According to the present invention, an eccentric arm is provided which may be mounted to a rotatable shaft (e.g. drive shaft) at a plurality of angles around the axis of rotation (e.g. offset by 180°). A selectable-angle eccentric arm comprises a shaft mount and a shaft lock, wherein the shaft lock is configured to engage and disengage the rotatable shaft when the eccentric arm is positioned at a plurality of angles rotatable to each other (e.g. offset by 180°).

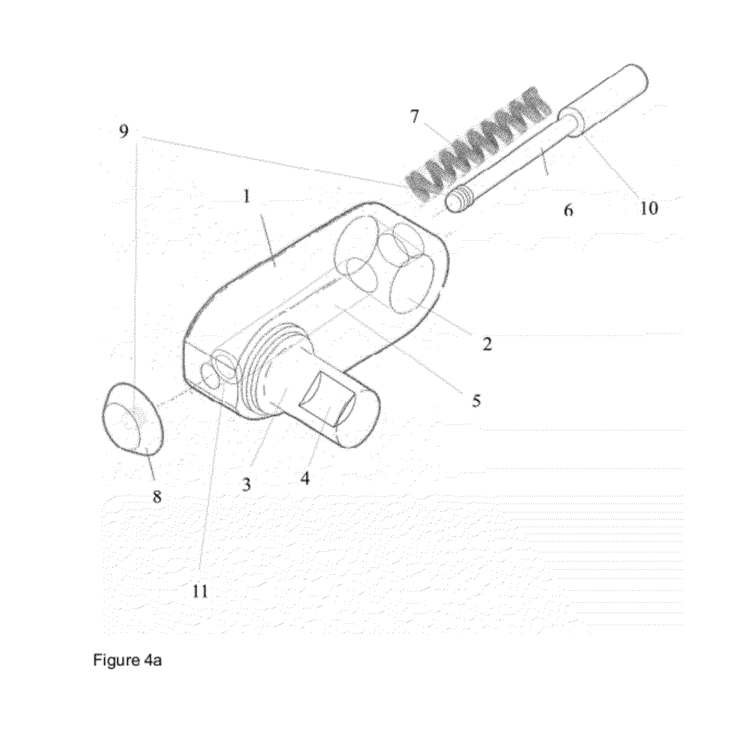

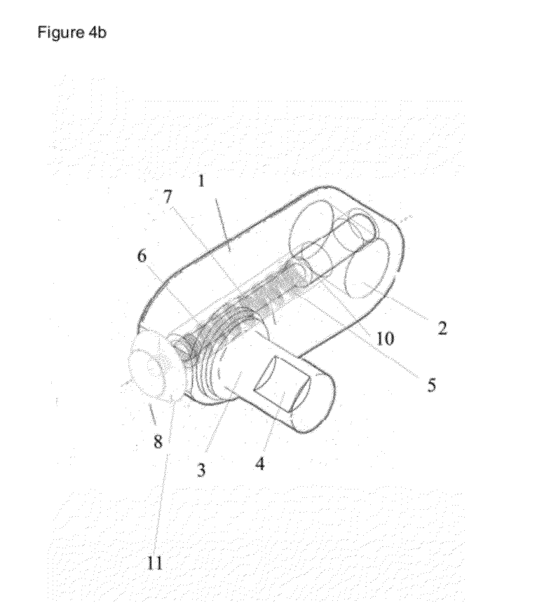

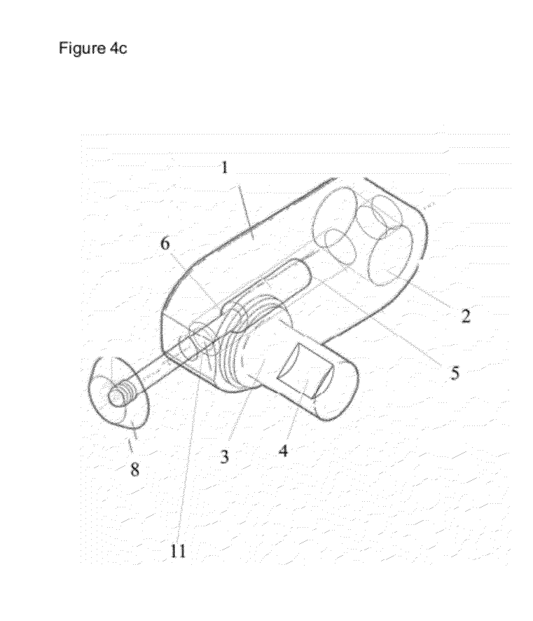

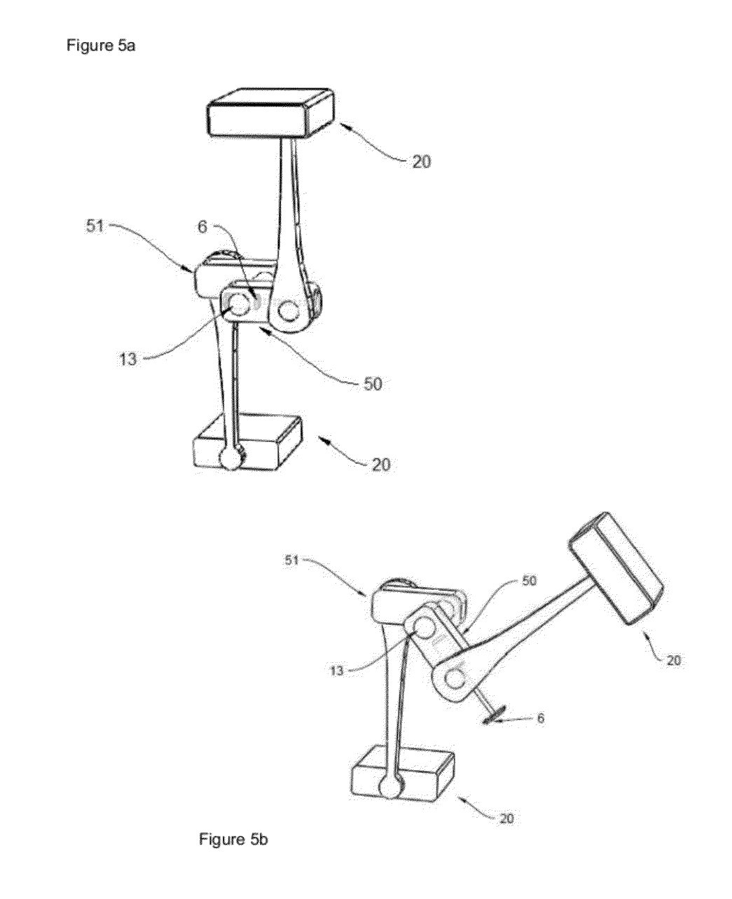

In one embodiment, the shaft mount is any member that engages a rotatable shaft to inhibit perpendicular movement of the eccentric arm relative to the axis of rotation (i.e. retraction of the eccentric arm from the shaft), for example, to allow the eccentric arm to “hang” freely on a horizontal rotatable shaft. For example, the shaft mount is optionally a cavity for acceptance of the rotatable shaft (e.g. cavity 2 in FIG. 4) or conversely a protrusion for insertion into the rotation shaft. Optionally, the shaft mount is configured to allow free rotation about rotatable shaft when the shaft lock is not engaged, for example, as depicted in FIGS. 5b, 17b, 19a, and 22a. With the teachings provided herein, the skilled artisan can configure the shaft mount in any manner provides such technical features.

In one embodiment, the shaft lock is a member which interacts with (e.g. contracts) the eccentric arm and the rotatable shaft when engaged and inhibits independent (e.g. free) rotation of the eccentric arm about the rotatable shaft (i.e. without also rotating the rotatable shaft). For example, a shaft lock is optionally any protrusion (e.g. drive shaft pin) that contacts a protrusion or cavity of drive shaft to inhibit rotation of the eccentric arm about the rotatable shaft. Generally, a shaft lock will contact the rotatable shaft at a location radially offset from the axis of rotation, e.g. in order to inhibit free rotation of the eccentric on the rotatable shaft (e.g. at passageways 32 in FIG. 22a or 17b). Optionally, the shaft lock contacts the rotatable shaft at any of the following locations: on or in the shaft mount (e.g. FIG. 17b) and/or near the axis of rotation (e.g. FIG. 17b), or at a location offset other than in the shaft mount (e.g. FIG. 22) and/or on the eccentric arm body (e.g. FIG. 22).

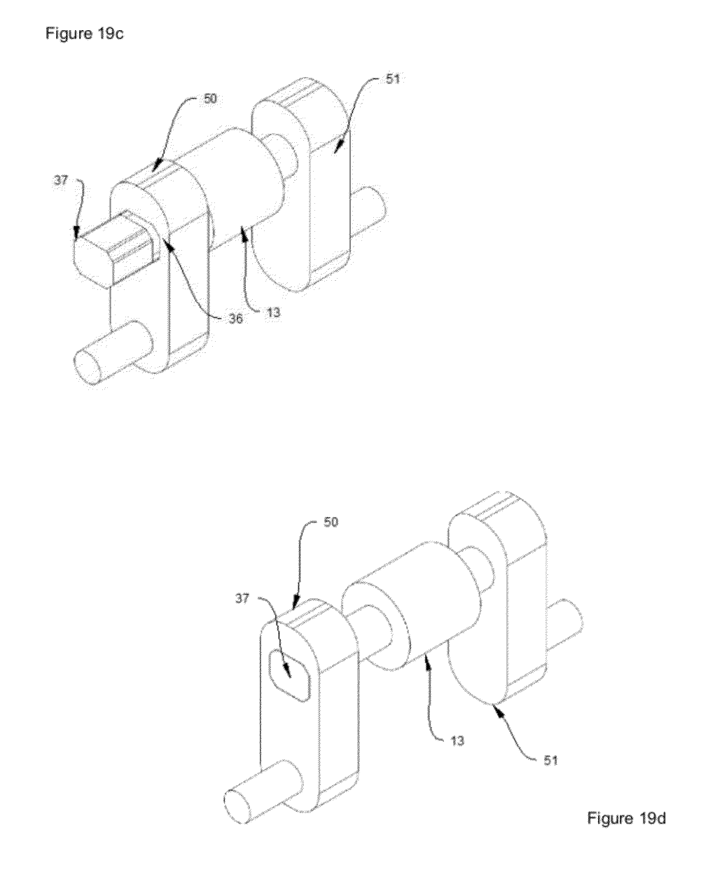

In one embodiment, the selectable-angle eccentric arm comprises a shaft mount having a cavity for acceptance of a rotatable shaft (e.g. an axial length thereof). When the rotatable shaft is provided horizontally (e.g. as depicted in FIGS. 1 and 2), such a selectable-angle eccentric arm can optionally be configured remain supported by the rotatable shaft, even when the shaft lock is disengaged, for example, as depicted in FIG. 5b, FIG. 19b, FIG. 21, FIG. 22.

In one embodiment (e.g. as set forth directly above), the shaft lock is an independent member (e.g. drive shaft pin) which interacts with (e.g. contacts) both the eccentric arm and the rotatable shaft when engaged (e.g. pin 6 depicted in FIG. 5 and FIG. 22). Such a shaft lock can interact, for example, with one or more passageways formed in the rotatable shaft (e.g. passageway 32 of FIG. 22).

In one embodiment, the shaft lock is a protrusion of or a cavity in the selectable angle eccentric arm (e.g. of or in the mount), for example, as depicted in FIG. 19). Optionally, the mount comprises a cavity for acceptance of an axial length of rotatable shaft. Optionally, the shaft lock is a member having a non-circular cross section with D2 symmetry. Such a protrusion or a cavity on the selectable angle eccentric arm can be configured to interact with a protrusion or cavity, respectively, in the rotatable shaft.

In one embodiment, the selectable-angle eccentric arm is specifically configured to be mounted on a rotatable shaft having either a protrusion (e.g. FIG. 18) or passageway (e.g. FIG. 17), wherein the drive shaft lock is configured to engage and disengage the rotatable shaft about the protrusion or passageway. Because traditional rotatable shafts are optionally provided as cylindrical members, such a protrusion or passageway provides, for example, an interface for (e.g. a member to impose an opposing force to) the shaft lock of the eccentric arm to inhibit rotation of the eccentric arm about the rotatable shaft when the shaft lock is engaged.

The skilled artisan will readily appreciate that, in some embodiments, the selection of an appropriate shaft lock is based, at least in part, on the selection of rotatable shaft or vice versa. With the teachings provided herein, the skilled artisan can now select functional combinations of a shaft lock and rotatable shaft.

In one embodiment, the shaft mount comprises a cavity for acceptance of a rotatable shaft, for example, as depicted in FIG. 17 and FIG. 18. Optionally, the rotatable shaft fits snugly in the cavity. Optionally, the cavity is substantially cylindrical (e.g. has a circular cross section) for acceptance of a cylindrical section of a rotatable shaft, for example, as depicted in FIG. 17. Optionally, the cavity has a non-circular cross section for acceptance of a non-cylindrical (non-circular) section of a rotatable shaft, for example, as depicted in FIG. 18. Optionally, the cavity comprises D2 symmetry for interfacing and mounting to a rotatable shaft at angles offset by 180°, for example, as depicted in FIG. 18. In such an embodiment, the non-cylindrical portions of the cavity can act as shaft lock by providing an extrusion or void in the shaft mount to interact with a void or extrusion in the rotatable shaft and inhibit rotation of the eccentric arm about the rotatable shaft when engaged.

Although the invention contemplates a selectable-angle eccentric arm comprising a cavity formed as a cutout in a solid member (e.g. as depicted in FIG. 9), the skilled artisan will readily appreciate that the term “cavity” embraces other types cavities which are not cutouts per se. For example, in one embodiment, a cavity is any member of collection of members which but are structurally and functionally equivalent in that they form a mount which accepts an axial length of rotatable shaft and optionally supports the eccentric arm on the rotatable shaft.

In one embodiment, the shaft mount comprises a key or keyway for alternate mounting to a plurality of keyways or keys placed about a rotatable shaft (e.g. offset by 180°).

In embodiment the selectable-angle eccentric arm is of the shaft pin (i.e. the shaft lock is a shaft pin) and comprises:
a. an eccentric arm body comprising:
   i. a shaft mount configured for mounting to a rotatable shaft (e.g. cavity 2 in FIG. 4);
   ii. a length of eccentric arm body extending radially from the shaft mount (e.g. body 1 in FIG. 4); and
   iii. a passageway through at least a first face of the eccentric arm body (e.g. passageway 5 of FIG. 4 through the sidewall of cavity 2; or passageway 5 of FIG. 22 through the external face of the eccentric);
b. a shaft pin (e.g. shaft pin 6 of FIG. 4 or 22) comprising a first end and a second end, wherein the shaft pin is configured to be inserted though the passage way in at least two positions
   i. a locking position in which the first end of shaft pin protrudes from the passageway at the first face (e.g. as in FIGS. 4b and 22a); and
   ii. an unlocked position in which the first end of the shaft pin is retracted into said passageway relative to the locking position (e.g. as in FIG. 4c).

Optionally, the passageway connects the first face to a second face of the eccentric arm body (e.g. a sidewall of cavity 2 and the external face connected by passageway 5 in FIG. 4; or the external faces connected by passageway 5 in FIG. 22) and the second end of the shaft pin is configured to protrude from the second face in both the locked and unlocked positions (e.g such that the pin endcap 8 is presented to the user as in FIG. 4 or FIG. 22).

Optionally, the shaft mount comprises a cavity for acceptance of an axial length of a rotatable shaft, optionally wherein the cavity is cylindrical (e.g. cavity 2 in FIG. 4 or 22). Optionally, wherein the first face is a sidewall of the cavity (e.g. as in FIG. 4).

Optionally, the selectable-angle eccentric arm comprising drive bar linkage means (e.g. a peg).

Optionally, the selectable-angle eccentric arm comprises a foot pedal or means for mounting a foot pedal (e.g. peg 3 with keyway 4 in FIG. 4).

### Shaft Lock

A selectable-angle eccentric arm of the present invention comprises a shaft lock for engaging the rotatable shaft to rotatably fix the eccentric am to the rotatable shaft. The shaft lock is not limited to any particular configuration, as long as it allows the user to secure the eccentric arm to the rotatable shaft at one or more of the plurality of angles. With the teachings provided herein, the skilled artisan can design shaft locks that allow such operation.

In one embodiment, the shaft lock is configured to engage and disengage the rotatable shaft when the eccentric arm is at any of a plurality of angles (e.g. offset by 180°).

In one embodiment, the shaft lock is any member that prevents rotation of the eccentric arm about a rotatable shaft when the shaft lock is engaged with the rotatable shaft.

In one embodiment, the shaft lock is any member that prevents rotation of the eccentric arm about a rotatable shaft when the shaft lock is engaged with the rotatable shaft and allows rotation of the eccentric arm about the rotatable shaft when disengaged.

In one embodiment, the shaft lock is any member that: a) prevents rotation of the eccentric arm about a rotatable shaft when the shaft lock is engaged with the rotatable shaft and b) either: unmounts the eccentric arm or allows unmounting of eccentric arm from the rotatable shaft upon disengagement.

In one embodiment, the shaft lock is a member which can move independently of (e.g. without moving) the eccentric arm (e.g. drive shaft pin 6 of FIG. 17). For example, the member can be configured to engage rotatable shaft when the eccentric arm is positioned about the rotatable shaft at any of a plurality of angles (e.g. offset by 180°).

In one embodiment, a shaft lock comprises an elongated member (“drive shaft pin”) that may be inserted through both the eccentric arm and the rotatable shaft such that the eccentric arm is rotatably secured to the rotatable shaft, for example, the elongated member 6, as shown in FIG. 4a or FIG. 22.

In such a drive shaft pin configuration, the drive shaft comprise means for engaging the shaft pin when the second eccentric arm is oriented about the rotatable shaft at the first angle and means for engaging the shaft pin the first eccentric arm is oriented about the rotatable shaft at a second angle, wherein the second angle is offset from the first angle. Such means for engaging the shaft pin can be a passageway (e.g. passageways 32 in FIG. 17b and FIG. 22). Alternatively, such means can be a protrusion that contacts the shaft pin and inhibits rotation of the eccentric arm about the shaft (i.e. without also rotating the shaft).

In another embodiment, a shaft lock of a selectable angle eccentric arm comprises a cavity with a non-circular cross section (e.g. cavity 25 of FIG. 9) for snug-fit acceptance and engagement of a portion of a rotatable shaft comprising a non-cylindrical protrusion (e.g. portion 24 of FIG. 9). The non-circular cross section (and the non-cylindrical protrusion of the rotatable shaft) can exhibit D2 symmetry (e.g. a rectangular prism) about the axis of rotation such that the protrusion can engage the cavity at two angles 180° offset. In the examples shown in FIG. 9, the cavity is in the shape of a square and therefore exhibits D4 symmetry in addition to D2 symmetry. However, optionally, the cavity (and protrusion) exhibit D2 symmetry but not D4 symmetry, as depicted in FIG. 19 such that the shaft lock can only engage the rotatable shaft at two angles 180° offset. Optionally, as depicted in FIG. 18, and FIG. 19., the shaft mount is provided by the cavity wall because it inhibits perpendicular movement or retraction of the eccentric relative to the axis of rotation. As an alternative to the configuration described above, the cavity with a non-circular cross section can be provided on the drive shaft and the non-cylindrical protrusion can be provided on the eccentric arm.

Optionally, the non-cylindrical cavity of the shaft lock is disengaged from the snug fit non-cylindrical portion of the rotatable shaft by pulling outwardly on the eccentric arm, where the eccentric arm may then be rotated and re-engaged at, for example, 180° offset. Alternatively, the non-cylindrical cavity of the shaft lock is disengaged from the snug fit non-cylindrical portion of the rotatable shaft by pushing outwardly on the eccentric arm, where the eccentric arm may then be rotated and re-engaged at, for example, 180° offset.

Optionally, the inner portion of the rotatable shaft (e.g. portion 38 in FIG. 18) is narrow enough to allow disengagement of the non-cylindrical cavity of the shaft lock by pushing inwardly on the eccentric arm and allows free rotation thereon (e.g. as shown in FIG. 19.

Optionally, the non-circular cross section (sometimes referred to as ‘non-cylindrical’) shaft lock is optionally biased (e.g. by spring) to a position where the non-cylindrical cavity interfaces the non-cylindrical portion of the rotatable shaft, thereby securing the eccentric arm at a fixed angle. The user may unlock the eccentric arm from the secured position by moving the eccentric arm to a position where the cavity surrounds a portion of the rotatable shaft that may rotate inside the cavity. Upon rotation of the rotatable shaft to a second angle relative to the eccentric arm, the user may release the eccentric arm and allow the spring to move the eccentric arm back into securing position where the non-cylindrical cavity surrounds the non-cylindrical portion of the rotatable shaft.

In another embodiment, a shaft lock comprise a friction pad or friction plate that is pressed against the drive shaft or component thereof. Such a configuration is similar to how a clutch plate works. Optionally, the friction pad or friction plate is biased for engaging the drive shaft.

In another embodiment, a shaft lock comprises a key or keyway which may be secured to a keyway or key, respectively, present on the rotatable shaft.

### Drive Bar

A device of the present invention (e.g. a human-powered dual action cycle) optionally comprises a drive bar for linking an eccentric arm to an oscillating lever (e.g. hand lever). Examples of drive bars or drive bars are well known in the art. For example, in one embodiment, any drive bar may be used, as long as back and forth movement of the oscillating lever causes rotation of the rotatable shaft by applying torque on the rotatable shaft through the eccentric arm.

In another embodiment, a drive bar is linked to a lever (e.g hand lever) by a pivot joint, for example, as depicted in FIGS. 1-3. For example, the drive bar may comprise a peg hole or peg for acceptance of a peg or peghole, respectively, present on the lever. Surprisingly, such a pivot linkage is especially useful in devices with selectable-angle eccentric arms according to the present invention. Devices of the present invention which comprise a pivot joint linking a drive bar and a lever provide one or more of the following superior properties compared to rolling or sliding linkages, for example, compared to the linkage present on the exercise device described by U.S. Pat. No. 4,824,102 (Lo).
a. increased safety and reduced likelihood of pinching and/or injuring of the user while switching between modes (e.g. tandem and out-of-phase movement), for example, because the location of the linkage (a possible pinch point) does not reposition itself about (e.g. move up and down on) the lever;
b. increased stability and ease of switching between modes (e.g. tandem and out-of-phase movement), for example, because the weight of the drive bar is supported by the pivot joint;
c. more precise relative positioning of the levers during operation (e.g. during tandem movement), for example, because the pivot joint location may fixed with respect to lever;
d. reduced unwanted variance in force during motion, for example, because the pivot joint location (fulcrum) may fixed with respect to lever;
e. reduction in irregular motion;
f. reduced wear and increased longevity;
g. a reduced number of parts; and
h. quicker assembly.

In one embodiment, the drive bar is long enough to separate the eccentric arm and the lever by a sufficient distance such that the eccentric arm and the lever do not cross paths (from a side view), for example, as shown in FIGS. 1-3, 7, and 14. Surprisingly, such a configuration eliminates pinch points and shearing action caused by the eccentric arm crossing paths with the lever to reduce the risk of injury while the user switches modes (e.g. from out-of-phase to tandem).

In another embodiment, a drive bar is linked to a lever (e.g hand lever) by a member which slides about the lever as the lever oscillates. Optionally, the slide comprises rollers which roll about the lever.

### Levers

A device of the present invention (e.g. a human-powered dual action cycle) may comprise a lever which oscillates back and forth to apply torque and rotate the rotatable shaft by linkage through the drive bar and eccentric arm. Examples of such levers are well known in the art.

Optionally, one or more levers will be pivotally attached to the frame to provide a fulcrum, and comprise a user interface or applied-force portion (e.g. hand-gripped portion) and a linkage to a drive bar (e.g. peg or peghole) to provide the load-bearing portion, as is known in the art.

Any type of lever may be used according the present invention. For example, the lever may be a class 1, 2, or 3 lever.

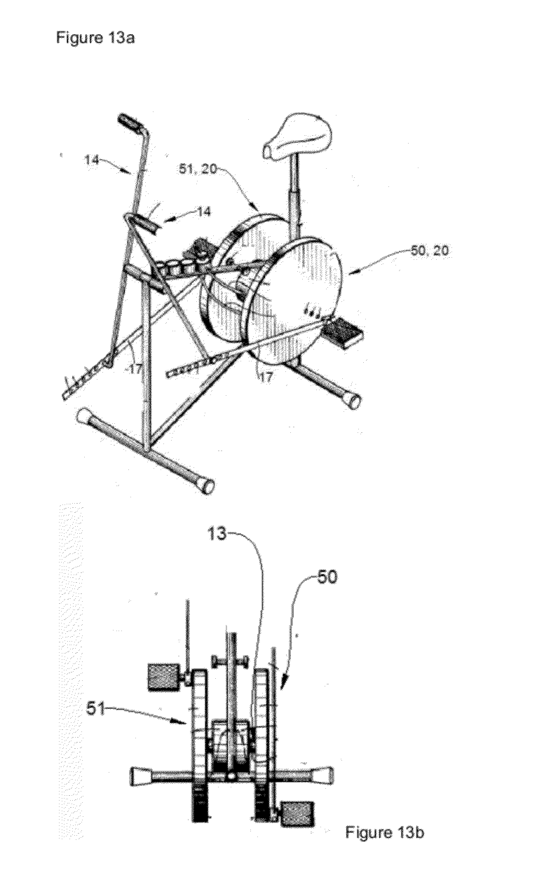

In one embodiment, a device comprises a class 1 lever. Class 1 levers comprise a fulcrum (e.g. frame-attached pivot) is located between the applied force (e.g. hand grip) and the load (drive bar linkage). In such a configuration, the force applied by the user (applied force) will generally oppose the force applied to the load. FIGS. 1, 3, 7 and 11-14 depict examples of devices with class 1 levers.

In one embodiment, a device comprises a class 2 lever. Class 2 levers comprise the load situated between the fulcrum and the force.

In one embodiment, a device comprises a class 3 lever. Class 3 levers comprise the applied-force between the fulcrum and the load.

Surprisingly, devices of the present invention with a selectable-angle eccentric arm and class 1 levers provide superior properties, for example, compared to the class 2 lever seen in the device described by U.S. Pat. No. 4,824,102 (Lo). Devices of the present invention comprising class 1 levers have one or more of the following superior properties:
a. increased safety and reduced risk of injury;
b. greater control over net torque (when in tandem mode);
c. allows greater tailoring of the lever arc length and leverage;
d. greater number of applications;
e. convenient placement of drive bar;

Dual action exercise devices such as those shown in FIGS. 1-3 are optionally configured with vertically-oriented levers and the user typically grasps the top (applied force) portion of the levers, as shown in FIG. 1.

The use of any type of lever may create a safety concern, for example, due to the shearing action against the frame caused by the back and forth movement lever, and the movement of pinch points (e.g. linkage to the eccentric arm). Moving pinch points and shearing action are of special concern when a user is switching between modes by unlocking the eccentric arm from the drive shaft and selecting a new angle for the eccentric arm. Surprisingly, however, the use of a class 1 lever in a device of the present invention reduces the risk of injury to the user. This is achieved, in part, because the class 1 lever places the drive bar linkage on the other side of the fulcrum (e.g. near the lower end of the device), where it is substantially less likely to injure the user, for example, while switching between modes (e.g. tandem and out-of-phase motion). This risk reduction is not seen, for example, with the use of a class 2 lever, which places the linkage portion at mid height, where there is substantially more risk of injuring the user while switching between modes.

Surprisingly, the use of a class 1 lever in a device according to the present invention allows greater control of net torque when in tandem mode. Traditional dual-action cycles provide merely for out of phase (alternating) back and forth movement of the hand levers where, during exercise, torque on the frame from one lever always opposes the torque from the other lever, resulting in a net torque of zero. However, the levers of a device of the present invention may be operated in tandem (e.g. rowing mode), where the torques from the levers are additive. Surprisingly, the net force applied to the levers of a device in tandem mode may even be sufficient to lift one end of the device frame off the ground or “pop a wheelie.” This may cause injury damage by toppling over or at hinder acceleration. Surprisingly, however, the use of a class 1 allows greater control over the net torque applied by the levers and can be designed with greater freedom to inhibit unwanted lift of the frame.

Surprisingly, the use of a class 1 lever in a device according to the present invention allows greater control of the lever arch length (e.g. at the hand hold) and/or leverage on the load (at the drive bar linkage). It is especially useful to have greater control of such properties in devices of the present invention having levers which may be operated in tandem mode. It is even more especially useful to have greater control of such properties in devices of the present invention having both levers and pedal which may be operated in tandem mode.

### Acceleration Resistance

In one embodiment, a human-powered device (e.g. dual action cycle) comprises a member to resist rotation of the ratable shaft or acceleration of rotation which is linked to the rotatable shaft of the eccentric arm. Examples of acceleration resistance members are well known in the art.

In one embodiment, an acceleration-resistance member is a member with inertia that gains momentum from rotation of the rotatable shaft (momentum carrying wheel or other means). Examples include flywheels and the like, for example flywheel 27 of FIG. 1. Surprisingly, such a momentum carrying means is especially useful when exercising in tandem mode, for example, as seen with leg presses, knee raises, hip thrusts, or other exercises where the user places their feet on pedals. Tandem mode optionally requires the user to position both their feet in the same position and operate both legs using the same force at the same time. This can create a “sticking point” for the user or a point in the tandem motion that is difficult for the user to pass through due to excess strain, for example, when both pedals are at the top of the circular path and both the users knees are maximally bent. A momentum carrying means such as a flywheel “pulls” the user through this sticking point, allowing the user to excercize without additional strain caused by a sticking point.

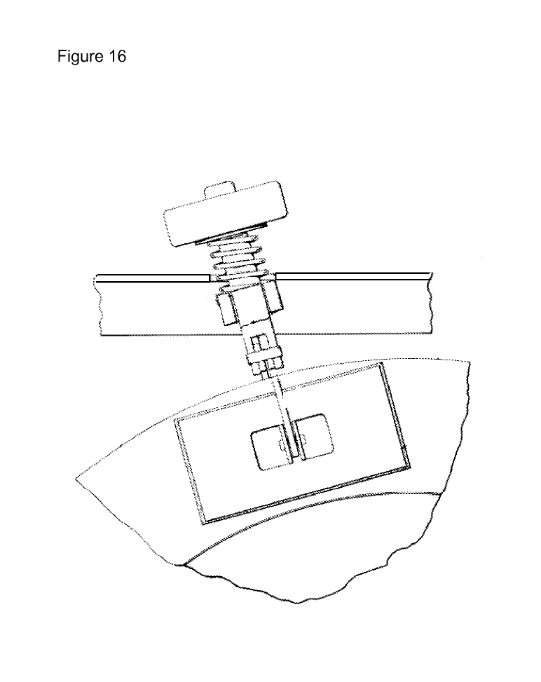

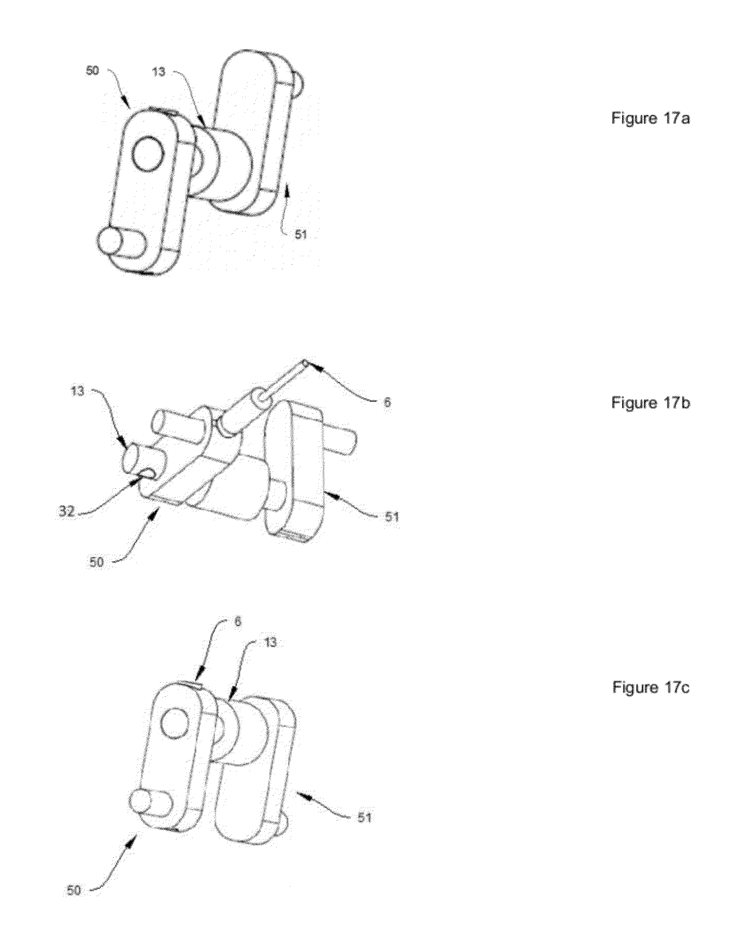

In one embodiment, an acceleration-resistance member which resists rotation of the rotatable shaft, but does not gain momentum. Examples include friction pads, resistance pins, and the like (e.g. as shown if FIGS. 15 and 16).

An acceleration-resistance member may directly attached or linked to the rotatable shaft itself or may be indirectly linked to the rotatable shaft, for example, through sprockets and chains.

### Drive Configurations

According to the present invention, a rotatable shaft is rotated or “driven” by applying torque on the rotatable shaft. The drive mechanism may be configured in any manner that applies torque the rotatable shaft upon a force input from a user or movable part (e.g. user force from pedaling or oscillating a lever).

In one embodiment, the rotatable shaft is rotated by a single force input or drive mechanism (“single action device”), for example, by a pair of levers (e.g. hand levers) that oscillate back and forth.

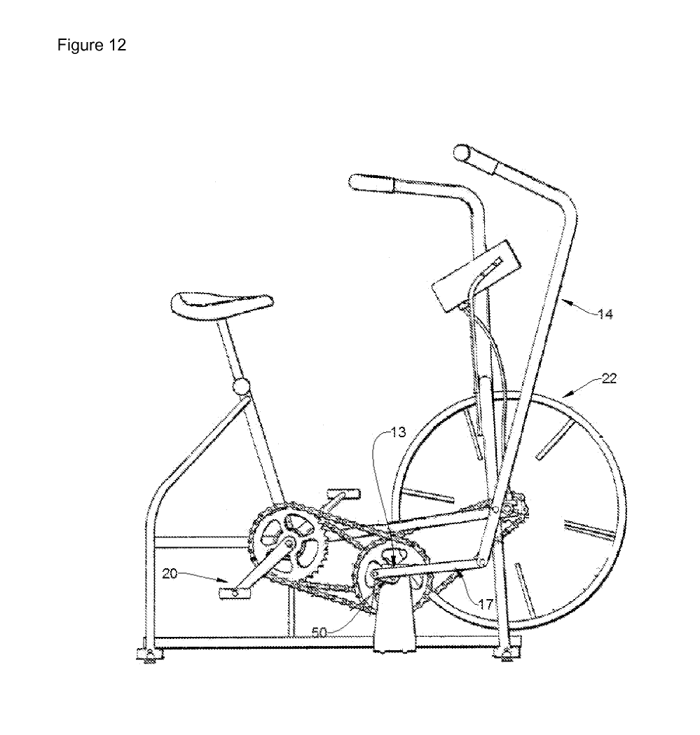

In another embodiment, the rotatable shaft is rotated by a multiple force inputs or drive mechanisms (“multiple action device”), for example, by levers (e.g. hand levers) that oscillate back and forth and pedaling action of the feet. Optionally, the multiple action device is a dual action device (e.g. a dual action cycle). Examples of dual action devices are shown in FIGS. 1-3 and 14. Optionally, the dual action device comprises two drive mechanisms which are both direct drive mechanisms with respect to the rotatable shaft (a “dual direct drive device”), for example, as shown in FIGS. 1-3 and 14. Optionally, the dual action device is an indirect drive mechanism with respect to the rotatable shaft, for example, as shown in FIGS. 11 and 12.

The torque applied to the rotatable shaft may be indirect or direct with respect to an applied force.

An “indirect drive” mechanism, as used herein, means a dual action device wherein the torque on the rotatable shaft is transmitted from a force input (e.g. user force from pedaling or oscillating a lever) through a second, intermediate rotatable shaft (e.g. sprocket, gear, or pully wheel), e.g. as depicted in FIGS. 11 and 12. Another example of an indirect drive is discussed, for example, in U.S. Pat. No. 4,824,102. An indirect drive device can typically be identified when force inputs such as crank arms (e.g. drive bar crank arm and pedal crank arm) are fixed to different rotatable shafts. Other examples are well known in the art and typically involve the use of sprockets, gears, and/or pulleys and may also incorporate teeth (e.g. cogs), belts, chains, and/or cables to transmit force between two different force inputs (e.g. different crank arms).

A “direct drive” mechanism, as used herein, means a dual action device wherein the torque on the rotatable shaft is transmitted from a force input (e.g. user force from pedaling and/or oscillating a lever) without the use of an intermediate rotatable shaft (e.g. sprocket, gear, or pully wheel) to transmit the force. The torque on the rotatable shaft in a direct drive mechanism is provided by two different force inputs (e.g. hand lever force and pedaling force) directly on the same rotatable shaft. Examples of direct drive mechanisms are shown in FIGS. 1-3, 7, 8, and 14.

A dual direct drive device according to the present invention (e.g. FIGS. 1-3, 7, and 14) provides one or more of the following superior properties compared to devices which comprise at least indirect drive mechanism, for example, compared to the dual action cycle described in U.S. Pat. No. 4,824,102:
a. increased efficiency and reduced friction (e.g. from belts or chains of an indirect drive);
b. increased longevity and reduced aging (e.g. belts or chains of an indirect drive);
c. increased drive stiffness (e.g. from mechanical backlash, hysteresis and elasticity caused by indirect drives);
d. elimination of previously required parts (e.g. the intermediate rotatable shaft of an indirect drive).

### Optional Configurations

In some embodiments, a dual action device comprising a selectable angle eccentric arm comprises a drive configuration shown in any of FIGS. 11-14.

### EXAMPLE 1

### Angle Selectable Eccentric Arm

FIG. 4 depicts one embodiment of a selectable angle eccentric arm of present invention. The eccentric arm comprises an eccentric arm body 1, a cavity 2 for acceptance of an axial length of a rotatable shaft (not shown), a radial length of eccentric arm body 1 extending from the cavity 2, drive bar linkage means such as a peg 3 for linking the eccentric arm body with a drive bar (not shown) positioned along said radial length of eccentric arm body and eccentric arm (e.g. pedal eccentric arm) linkage means such as a key-way 4 provided on peg 3 for mounting a crank arm (not shown). The eccentric arm further comprises a passageway or port or passageway 5 connecting one face (e.g. sidewall of the cavity 2) with another face (e.g. the exterior of the eccentric arm body 1) and an elongated shaft-locking member 6 or “drive shaft pin” that is inserted or is capable of being inserted both though port 5 and an aligned port in a rotatable shaft (not shown) which inserted into the cavity 2 (e.g. a hole drilled in a primary drive shaft of an exercise cycle).

When the eccentric arm is in use (e.g. mounted on the drive shaft of an exercise cycle), the shaft-locking member 6 is capable of being inserted in two positions, a locked position and an unlocked position. FIG. 4b depicts the locked configuration in which the shaft-locking member 6 protrudes into cavity 2 and secures the eccentric arm to a rotatable shaft which will be inserted into cavity 2. The shaft-locking member 6 is biased in the locked position (i.e. for engagement with the drive shaft) by biasing means such as a compression spring 7, which interfaces the shaft-locking member 6 at bushing 10 and the eccentric arm body at bushing 11. FIG. 4c depicts the unlocked configuration in which the shaft-locking member 6 is retracted from said cavity to allow free rotation of the eccentric arm around the rotatable shaft (not shown).

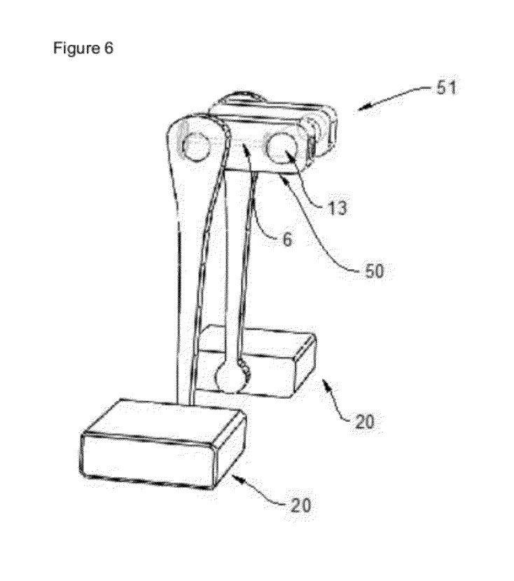

In order to install the selectable angle eccentric arm on an existing dual action cycle, one of the pre-existing eccentric arms is removed from the drive shaft and a hole is drilled in the driveshaft to accept the shaft-locking member. The pre-existing eccentric arm may be discarded and replaced with the selectable angle eccentric arm. In order to allow the traditional pedaling motion with the user's feet while the arms are moved back and forth out of phase with each other (e.g. similar to that of prior art FIGS. 1-3), the selectable angle eccentric arm is locked in a position which is offset 180° from the other eccentric arm, as seen FIG. 5A. When the user wishes to switch to a rowing motion in which the arms synchronously (in tandem) move back and forth together, the user disengages the shaft-locking member 6 from the drive shaft by moving shaft-locking member 6 to the unlocked position (as seen in FIGS. 4c and 5b) and rotates the selectable angle eccentric arm 180° such that it is not offset (i.e. parallel) with the other eccentric arm (as seen in FIG. 6) and then re-engages the shaft-locking member 6 with the drive shaft.

Surprisingly, the design of the selectable angle eccentric arm allows the user to switch between traditional movement and rowing movement on-the-fly simply by reaching down with his hand and pulling on end cap 8 which is coupled to the shaft-locking member 6 by a screw lock comprising interacting male/female members 9. Pulling on end cap 8 disengages the shaft-locking member 6 to unlock the drive shaft. Still grasping only the end cap 8, the user may then rotate the adjustable-eccentric arm. At any point during the 180° rotation, the user may release the end cap 8 because, if biasing means 7 is provided, the shaft-locking member 6 will automatically spring into locking position upon reaching the opposite end of the hole drilled in the drive shaft.

The selectable angle eccentric arm described provides one or more of the following improvements over the prior art cycle/row combination machines such as described by U.S. Pat. No. 4,824,102 (Lo):
a. allow on-the-fly switching between rowing and cycling with minimal interruption and without dismounting the seat of the exercise machine;
b. allow switching between rowing and cycling with the use of a single hand;
c. do not require the incorporation of several additional movable parts and have increased longevity;
d. are easily amenable as after-market modifications and require few steps to install;
e. are more aesthetically pleasing when installed as an after-market modification; and
f. provides a safer mechanism for switching between rowing and cycling.

### EXAMPLE 2

### Dual Action Exercise Device

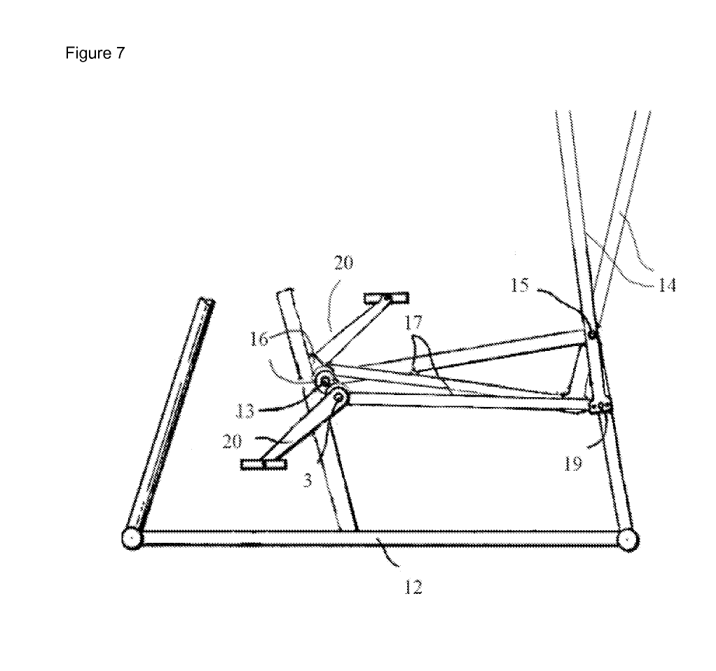

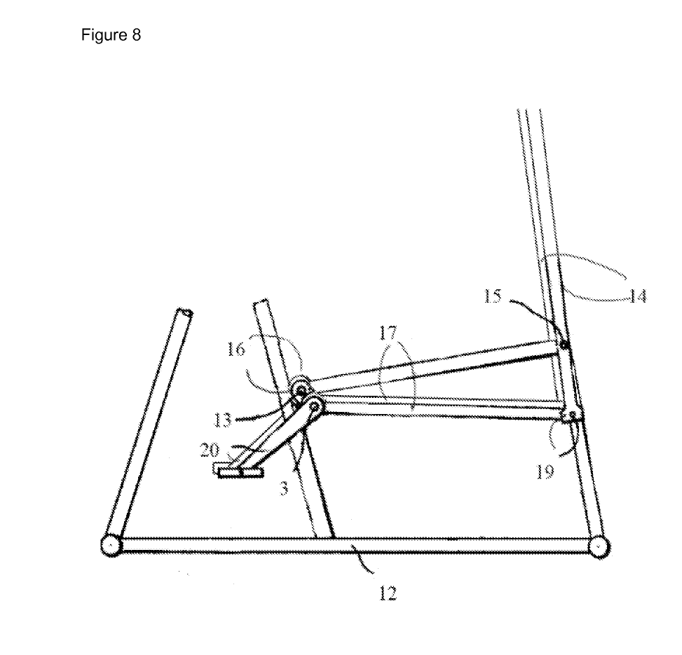

FIG. 7 and FIG. 8 depict the lower end of a device comprising a selectable angle eccentric arm. The device comprises a frame 12, a drive shaft 13 rotatably carried by the frame 12, a pair of levers (e.g. hand levers) 14 pivotally mounted 15 to the frame for oscillating back and forth movement, a pair of eccentric arms 16 mounted to and extending radially from the drive shaft 13, a pair of drive bars 17 linking the hand levers 14 to the respective eccentric arms 16 such that back and/or forth movement of the hand levers 14 about said pivot 15 induces rotation of the drive shaft 13 by applying torque through the eccentric arms 16. The drive bars 17 may be pivotally linked 19 (e.g. peg/peghole) to the hand levers 14 and also may be pivotally linked 3 (e.g. peg/peghole) to the eccentric arms 16. The device also comprise crank arms (e.g. pedal crank arms) 20 which extend from the drive shaft 13 and are fixed to respective eccentric arms 16 on pegs 3 (eg. on a keyway of peg 3). Note that the eccentric arms 16 in FIG. 7 and FIG. 8, as well as elsewhere, are depicted as having separate components 16 and 20 oriented at an angle to form a crank arm; however, the crank arm 20 can be formed as a single body with the eccentric arm 16 and is not limited to crank arms having an angled body.

One of the eccentric arms 16 is a selectable angle eccentric arm (e.g. as described in Example 1) and comprises a drive shaft lock capable of engaging and disengaging the drive shaft. When the shaft lock is engaged, the eccentric arm is fixed to the drive shaft. When the shaft lock is disengaged, the eccentric arm is not fixed to the drive shaft. For example, as shown in FIG. 17, a drive shaft lock comprising the shaft-locking member (shaft pin) 6 of the selectable angle eccentric arm 50 may be engaged (as in FIGS. 17a and 17c) and disengaged (as in FIG. 17b) from one or more ports or passageways 32 drilled in the drive shaft to accept the drive shaft lock. The other eccentric arm 51 need not be a selectable angle eccentric arm and can have a single keyway for acceptance of a single key on the drive shaft at only one angle, as is typically seen on exercise devices in the prior art.

As shown in FIGS. 5a, 7, and 17a, the shaft lock is engaged with the drive shaft 13 in a first position and the selectable angle eccentric arm of the pair of eccentric arms 16 is fixed to the drive shaft at a first angle 180° offset relative to the second eccentric arm of the pair. Upon disengaging the shaft lock 6 from the drive shaft 13, as depicted in FIG. 5b and FIG. 17b, the user may rotate the selectable angle eccentric arm about the drive shaft 13 and then reengage the shaft lock with the drive shaft 13 in a second position in which the first eccentric arm is fixed to the drive shaft at a second angle not offset relative to the second eccentric arm of the pair, as depicted in FIG. 6 and FIG. 17c. The hand levers oscillate 180° out of phase in the traditional manner when the first eccentric arm is fixed at the first angle as shown in FIG. 17a and FIG. 7 and oscillate in phase (in tandem) in a rowing manner when the first eccentric arm is fixed at the second angle as shown in FIG. 8 and FIG. 17c.

Such a device provides one or more of the following superior properties, for example, over devices such as that described by U.S. Pat. No. 4,824,102 (Lo).
a) although the drive shaft may further be linked to a second rotatable shaft (e.g. shaft 21 carrying a flywheel 22, as shown in FIG. 2), a second rotatable shaft is not required for basic function;
b) allows placement of the shaft lock proximal to the user for on-the-fly repositioning of the selectable angle eccentric arm;
c) provides direct linkage of both the levers and the crank arms to the drive shaft, as taught herein;
d) if a pedal crank arm is fixed to the eccentric arm, the device provides for tandem motion of both the levers and the crank arms, for example tandem hand motion and tandem foot motion, allowing, for example a greater amount of energy may be expended and a longer duration of use
e) may use simple pivot joints between levers and drive bars;
f) may use type 1 levers in an effective manner;
g) may be manufactured with reduced resources;
h) increased longevity and reduced maintenance;
i) may be assembled with greater ease;
j) eliminates pinch points;
k) allows the user to reposition the selectable angle eccentric arm with a single hand.

### EXAMPLE 3

### Selectable Angle Eccentric Arm with D2 symmetry

FIG. 18 and FIG. 19 depict rotatable shaft with a selectable angle eccentric arm 50 and another eccentric arm 51. As a shaft lock, the selectable angle eccentric arm 50 comprises cavity with a non-circular cross section with D2 symmetry 36, such as a rectangular cross section. The cavity 36 also acts as a mount for the eccentric arm. The cavity 36 accepts protrusion 37, a length of the rotatable shaft 13 which has a non circular cross section with D2 symmetry, for example, the complement of the cavity 36 for a snug fit between protrusion 37 and cavity 36. Optionally, the eccentric arm 50 comprises biasing means (e.g. spring) for biasing cavity 36 to engage protrusion 37 (biasing means not shown). The other eccentric arm 51 can be any eccentric arm, for example, it may be a standard (single angle) eccentric arm with a single keyway for acceptance of a single key on shaft 13 (key/keyway not illustrated).

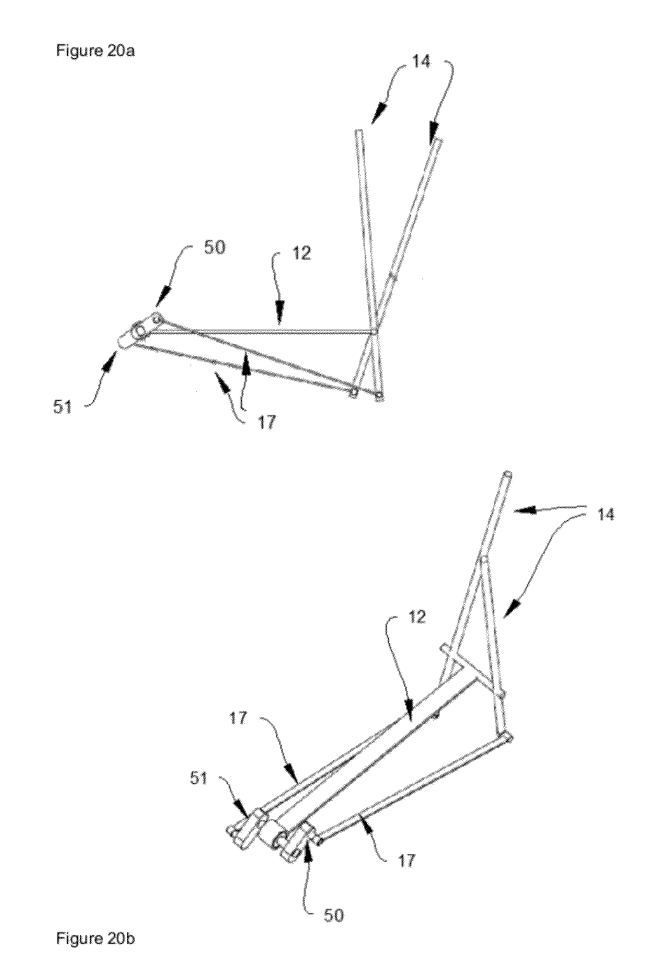

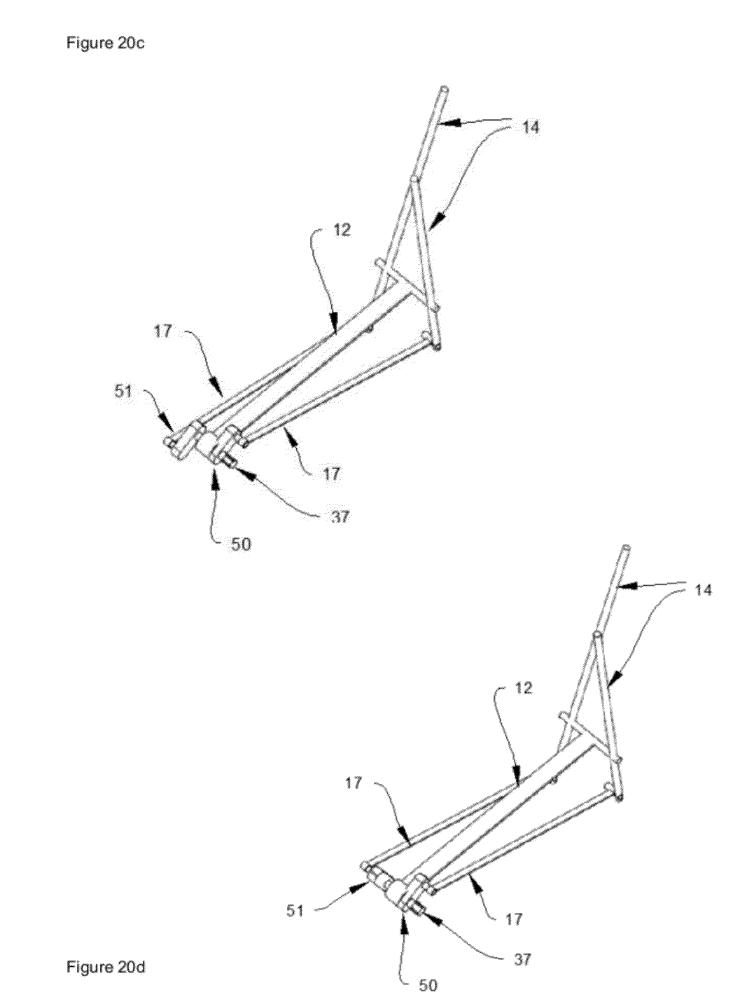

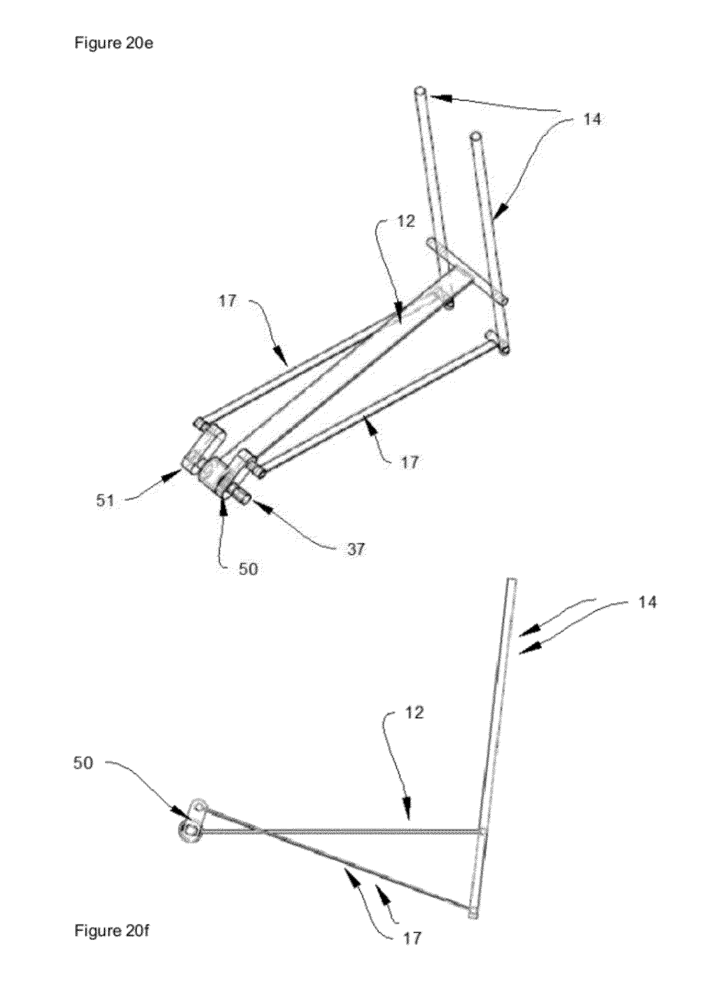

To change between alternating mode and tendem mode, the shaft lock 36 can be disengaged from the protrusion 37, as depicted in FIG. 19a followed by rotation of the eccentric arm 51, as depicted in FIG. 19b, until it is in the tandem position as depicted in FIG. 19c, and then reengaged with protrusion 37. This process is depicted in FIG. 20a-20f on a device with hand levers 14 linked to eccentric arms 50, 51 by drive bars 17 on frame 12. However, the eccentric arms can further comprise pedals (not shown). Alternatively, the device does not comprise hand levers 14 (or drive bars 17) but comprise 18 (e.g. as in FIG. 21).

### EXAMPLE 4

### Selectable Angle Eccentric Arm with Shaft Pin

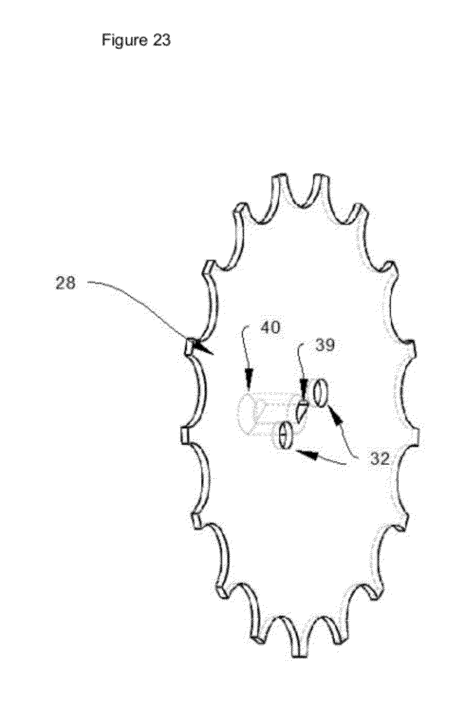

FIG. 22 depicts a sprocket 28 with a selectable angle eccentric arm 50 mounted there on. The sprocket 28 is itself a part of a rotatable shaft or is configured for mounting on a rotatable shaft, for example, by providing keyway 39 for acceptance of a key on a rotatable shaft, as depicted in FIG. 23. The sprocket comprises a peg 40 or acceptance of a cavity 2 of an eccentric arm and passageways 32 offset by 180° for engagement of a drive shaft pin 6 at either passageway. Alternatively, the peg 40/cavity 2 relationship can be reversed (i.e. with a cavity on the sprocket). Although a sprocket 28 with teeth is depicted, this plate could alternatively be a pulley or any other portion of a rotatable shaft.

The selectable angle eccentric arm is similar to that depicted in FIG. 4 except that the passageway 5 is substantially parallel to the axis of rotation. As depicted in FIG. 22b, the passageway 5 can be configured to connect two faces of the eccentric arm 50 such the drive shaft pin 6 can be inserted through passage way 5 and then further into one of passageways 32 to engage the drive shaft.

### EXAMPLE 5

### Bicycle with Selectable Angle Eccentric Arm

FIG. 21 depicts a device of the present invention comprising two eccentric comprising pedals 34, wherein one of the eccentric arms is a selectable angle eccentric arm 50. The device is configured to operate in pedaling mode when the eccentric arms are out of phase. For tandem mode, the device can be a operated as a leg press (where the pedals rotate in tandem). Additionally or alternatively, the pedals comprise foot straps 35 so that the device can be operated in knee raise (or abdominal crunch) mode.

In one embodiment, the device comprises a seat 26. Optionally, the device comprises a backrest 30 or other means for stabilizing the user while performing leg presses. Additionally or alternatively, the device further comprises handholds 31 or other means for stabilizing the user while performing knee raises.

The device is depicted as a recumbent bike (where the vertical difference between the seat and the pedals is the same or less (e.g. substantially less) than the horizontal difference between the seat and the pedals). However, in an alternative embodiment, the device is an upright excursive device.

The selectable angle eccentric arm 50 can be configured in any manner. For example, the selectable angle eccentric arm 50 be of the shaft pin type, comprising a passage way 33 that independently aligns with either of passageways 32 of the drive shaft 13 such that a drive shaft pin 33 can be inserted there through (in a similar manner to that shown in FIG. 22). Alternatively, the eccentric arm is configured in any manner taught herein.

### EXAMPLE 6

### Dual Action Elliptical with Selectable Angle Eccentric Arm

FIG. 14 depicts a dual action device of the present invention. The device is an elliptical machine comprising a drive shaft 13 with eccentric arms mounted thereon. One of the eccentric arms is a selectable angle eccentric arm 50. The eccentric arms are linked to hand levers 14 by drive bars 17 in a similar manner to that of FIGS. 2, 3, 7, and 8, except that the pedals 34 are linked to the eccentric arm by providing them on drive bars 17. The device can be operated in offset mode to perform an elliptical (pedaling) exercise or in tandem mode to perform hip thrusts where the user pulls back while thrusting their hips forward.

In one embodiment, the shaft lock is of the drive shaft pin type, as described herein.

The citations provided herein are hereby incorporated by reference for the cited subject matter.

We claim:

1. A selectable-angle eccentric arm comprising:
a. an eccentric arm body comprising:
i. a shaft mount configured for mounting to a rotatable shaft;
ii. a length of eccentric arm body extending radially from the shaft mount; and
iii. a passageway through at least a first face of the eccentric arm body;
b. a shaft pin comprising a first end and a second end, wherein the shaft pin is configured to be inserted though the passage way in at least two positions
i. a locking position in which the first end of shaft pin protrudes from the passageway at the first face; and
ii. an unlocked position in which the first end of the shaft pin is retracted into said passageway relative to the locking position; and
c. optionally, means for biasing the shaft pin in the locking position.

2. The selectable-angle eccentric arm of claim 1, wherein:
a. the passageway connects the first face to a second face of the eccentric arm body; and
b. the second end of the shaft pin is configured to protrude from the second face in both the locked and unlocked positions.

3. The selectable-angle eccentric arm of claim 1, wherein the shaft mount comprises a cavity for acceptance of an axial length of a rotatable shaft, optionally wherein the cavity is cylindrical.

4. The selectable-angle eccentric arm of claim 3, wherein the first face is a sidewall of the cavity.

5. The selectable-angle eccentric arm of claim 1, further comprising drive bar linkage means.

6. The selectable-angle eccentric arm of claim 1, further comprising a foot pedal or means for mounting a foot pedal.

7. A drive mechanism comprising a rotatable shaft and first and second eccentric arms, extending radially from the drive shaft, wherein:
a. the first eccentric arm is oriented about the rotatable shaft at a first angle;
b. second eccentric arm is the selectable angle eccentric arm of claim 1;
c. the rotatable shaft comprises:
i. means for engaging the shaft pin when the second eccentric arm is oriented about the rotatable shaft at the first angle;
ii. means for engaging the shaft pin the first eccentric arm is oriented about the rotatable shaft at a second angle, wherein the second angle is offset from the first angle.
wherein the first and second eccentric arms rotate in tandem when the first eccentric arm is rotatably fixed to the drive shaft at the first angle and rotate in out of phase when the first eccentric arm is rotatably fixed to the drive shaft at the second angle.

8. An exercise device comprising:
a. a frame;
b. a drive shaft rotatably carried by the frame;
c. first and second eccentric arms, each extending radially from the drive shaft; wherein:
i. the second eccentric arm is oriented about the rotatable shaft at a first angle;
ii. the first eccentric arm of the pair of eccentric arms is a selectable angle eccentric arm comprising a drive shaft lock configured to engage and disengage the first eccentric arm from the drive shaft; wherein:
the first eccentric arm is rotatably fixed to the drive shaft when the shaft lock is engaged with the drive shaft; and
the first eccentric arm is rotatably free from the drive shaft when the shaft lock is disengaged from the drive shaft;
iii. the drive shaft lock is configured to engage the drive shaft when the first eccentric arm is oriented about the drive shaft at the first angle and when the first eccentric arm is oriented about the drive shaft at a second angle offset relative to the first angle; and
iv. the first and second eccentric arms rotate in tandem when the first eccentric arm is rotatably fixed to the drive shaft at the first angle and rotate in out of phase when the first eccentric arm is rotatably fixed to the drive shaft at the second angle; and
d. optionally, a means for biasing the drive shaft lock to engage the drive shaft.

9. The exercise device of claim 8, further comprising:
a. first and second hand levers pivotally mounted to the frame for oscillating movement;
b. first and second drive bars linking the first and second hand levers to the respective first and second eccentric arms, whereby movement of the hand levers about said pivot mount cranks the eccentric arms and induces rotation of the drive shaft.

10. The exercise device of claim 9, wherein the first and second eccentric arms further comprise respective foot pedals.

11. The exercise device of claim 9, wherein the drive bars and the hand levers are linked by pivots joint, wherein:
a. the hand levers comprise pegs and the drive bars comprise peg holes for accepting the pegs; or
b. the drive bars comprise pegs and the hand levers comprise peg holes for accepting the pegs.

12. The exercise device of claim 9, wherein the hand levers are type 1 levers, each comprising:
a. a user hand hold;
b. a drive bar linkage; and
c. a frame mount for said pivotally mounting to the frame, wherein the frame mount is positioned between said hand hold and said drive bar linkage.

13. The exercise device of claim 9, wherein the drive bars are provided with a sufficient length such that the eccentric arms and the hand levers do not cross paths during rotation of the drive shaft and oscillating movement of the hand levers.

14. The exercise device of claim 8, wherein the wherein the first and second eccentric arms further comprise respective foot pedals.

15. The exercise device of claim 14, wherein the foot pedals comprise respective foot straps.

16. The exercise device of claim 8, wherein first eccentric arm is rotatably carried by the drive shaft, wherein the first eccentric arm comprises a drive shaft mount configured to freely to rotate about the drive shaft when the drive shaft lock is disengaged.

17. The exercise device of claim 16, wherein:
a. the first eccentric arm comprises a passageway;
b. the drive shaft lock comprises a drive shaft pin comprising a first end and a second end, wherein the drive shaft pin is configured to be inserted though the passage way in at least two positions:
i. a first position in which the first end of shaft pin protrudes from the passage and engages the drive shaft; and
ii. a second position in which the first end of the shaft pin is retracted into said passageway relative to the first position and disengaged from the drive shaft.

18. The exercise device of claim 8, wherein
a. the drive shaft comprises a non-circular axial length of drive shaft having D2 rotational symmetry with respect to the drive shaft axis;
b. the drive shaft lock of the first eccentric arm comprises a cavity for acceptance of the non-circular axial length of drive shaft, wherein the shaft lock is engaged with the drive shaft upon acceptance of the non-circular axial length of drive shaft;
c. optionally, the cavity comprises substantially the same shape as the non-circular axial length of drive shaft having D2 rotational symmetry; and
d. optionally, the non-circular axial length of drive shaft and the cavity are substantially in the shape of a rectangular prism.

19. The exercise device of claim 8, wherein the drive shaft comprise a sprocket.

20. The exercise device of claim 14, wherein the drive shaft is linked to acceleration-resistance means or momentum-carrying means.
